(19) United States
(12) Patent Application Publication
(10) Pub. No.: US 2006/0177595 A1
(43) Pub. Date: Aug. 10, 2006

(54) Method and device for the drying of lacquer coatings

(75) Inventors: Reiner Pocher, Rheda-Wiedenburck (DE); Reingard Pelster, Marienfeld (DE)

Correspondence Address: HEDMAN & COSTIGAN P.C., 1185 AVENUE OF THE AMERICAS, NEW YORK, NY, 10036, US

(73) Assignee: Venjakob Maschinenbau GmbH & Co.KG

(21) Appl. No.: 11/327,628

(22) Filed: Jan. 6, 2006

(30) Foreign Application Priority Data
Jan. 13, 2005 (DE) 102005001683.9

(51) Int. Cl. B05D 3/00

(52) U.S. Cl. 427/532; 118/641; 118/62; 118/69

(57) ABSTRACT

In the case of a method and a device for the drying of a solvent-containing lacquer coating (7) applied to a workpiece (6), a particularly thorough and lacquer-sparing evaporation (II) is achieved by a feed (8a) of moisture- and chill-conditioned air onto the workpiece (6) with simultaneous energy input into the lacquer coating (7) by exposure to electromagnetic radiation (5). With the method according to the invention and the device according to the invention, the formation of coating defects during a drying (III) following the evaporation (II) is efficaciously avoided.

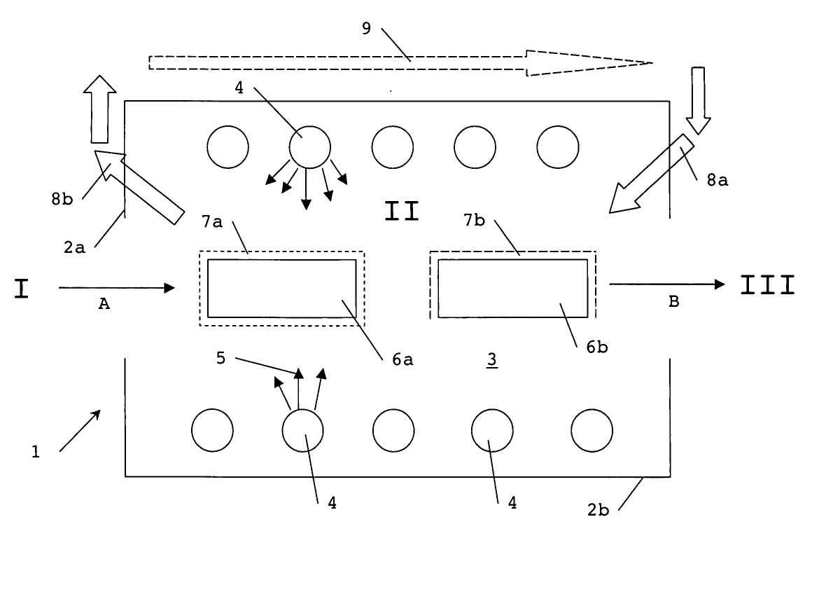

### FIELD OF THE INVENTION

The invention relates to a method and a device for the drying of a solvent-containing lacquer coating applied to a workpiece.

### STATE OF THE ART

Every lacquer consists of a film-forming substance—the so-called lacquer body or binder—which is dissolved in a volatile solvent or solvent mixture. Depending on the type of lacquer, pigments, fillers, siccatives, plasticizers, curing agents or other additives are also used.

With lacquers, drying means the transformation of the liquid lacquer coating applied to a body into a solid film which is to protect and enhance the coated body.

During this process, changes take place in the physical and chemical properties of the lacquer coating which first impart the desired characteristic properties.

The drying process involves the following sequence of steps: physical drying (evaporation of the solvent) and curing of the coating by colloidal changes and/or chem. cross-linking reactions (polymerization, polyaddition, polycondensation) that pass seamlessly into one another.

The physical drying is usually carried out as a first step after lacquer application, beginning with the evaporation of the solvent out of the lacquer coating by passing the coated workpiece through as dust-free as possible an area at room temperature or slightly increased air temperature up to a maximum of 30 to 40° C. In this evaporation zone, the applied lacquer coating is to homogenize and bond to the surface of the workpiece. The lacquer pigments are optionally also to develop a specific orientation and lamination. In addition, during this evaporation, a large portion of the volatile constituents of the lacquer is to evaporate.

The evaporation phase is followed by the forced drying or also curing process. The remaining volatile constituents are expelled and the cross-linking reactions proceed. This can optionally be accompanied by a feed of energy with a temporary increase in the temperature of workpiece and lacquer coating.

During the first drying stage, i.e. the evaporation of the lacquer coating, it is decisive that the lacquer coating remains open to diffusion, in particular on its surface in contact with the air, as otherwise volatile constituents lying below the surface can no longer evaporate to a sufficient extent.

If the surface of the lacquer coating does not remain sufficiently permeable in the evaporation phase, the volatile constituents remain partly “trapped” inside the lacquer.

This proves disadvantageous in the subsequent forced drying process.

In fact the trapped constituents, as a result of the amplified energy effect taking place there, cause coating defects in the lacquer such as e.g. bubbles (so-called “cookers”), shrinkage cracks or partial clouding.

### THE OBJECT OF THE INVENTION

It is consequently an object of the present invention to propose a method and a device for the drying of lacquer coatings in which the formation of coating defects during the drying can be reliably avoided. In particular, a good evaporation is to be achieved in the evaporation phase by ensuring the permeability of the lacquer surface.

### DESCRIPTION OF THE INVENTION

To achieve the object just named, the present invention proposes a method for the drying of a lacquer coating applied to a workpiece, the method having the following step:
Feeding of moisture- and chill-conditioned air onto the workpiece with simultaneous energy input into the lacquer coating by exposure to electromagnetic radiation.

As a result of the supply of moist and cool air, the evaporation process on the surface of the lacquer coating is slowed down. The lacquer surface is kept cool, it cannot dry out during the evaporation, but remains moist and as a result permeable. The development of a disruptive, diffusion-inhibiting surface is avoided. At the same time, the volatile constituents below the surface are excited by the incident electromagnetic radiation and efficaciously expelled from the lacquer. The electromagnetic radiation introduces energy into the lacquer coating with the result that the evaporation of the contained volatile elements is promoted over the whole coating cross-section.

Within the framework of the invention, by solvent-containing lacquer is meant all lacquers that contain a liquid solvent or also solvents. The solvent is preferably water, but other solvents are also included.

The conditioned air is an air that is provided for use for the evaporation and its temperature and air humidity are adapted and prepared accordingly. It is therefore not simple room or ambient air.

According to the invention, the conditioned air is fed to the workpiece. This means e.g. that the air is directed towards the workpiece or blown onto same. Other types of air feed are also conceivable. Thus e.g. the air can be introduced into an isolated room in which the coated workpiece is located. The only essential thing is that an exchange between the fed air and the surface of the lacquer coating can take place. The conditioned air is to be able to come into contact with the lacquer coating, i.e. the air is to be brought together with the lacquer coating.

The energy input into the lacquer coating is achieved by irradiating the lacquer coating with electromagnetic radiation. This takes place e.g. through suitable radiation sources, the emissions from which are directed onto the coated workpieces. The electromagnetic waves or beams thus penetrate the lacquer coating and are absorbed by the solvent contained in the lacquer. As a result of this energy supply or also heating, the solvent can escape from the lacquer via the permeable surface.

In a preferred version of the method according to the invention, the conditioned air is conditioned to a temperature in the range from +1° C. to +18° C. and/or an air humidity in the range from 50% to 90% relative humidity. At these temperature and moisture values, the surface of the lacquer coating can be kept particularly well permeable. The temperature range from 1 to 18° C. guarantees a good cooling and the moisture range of 50 to 90% a good moistening of the surface.

The energy is preferably also input into the workpiece, i.e. the electromagnetic radiation also at least partly penetrates directly into the workpiece and is absorbed there by the workpiece. As a result of the heating of the thus-occurring workpiece, the evaporation of the volatile constituents in the lacquer coating from the lacquer coating/workpiece contact surface is promoted still further.

Furthermore, the conditioned air can optionally be fed in the form of fresh air or in the form of circulating air. Where fresh air is supplied, new, unused air is constantly fed to the workpiece. If a circulation system is provided, there is simply a constantly renewed feed of already fed air, this air being repeatedly prepared and conditioned. With circulating air, the same quantity of air is therefore circulated, whereas with the fresh air feed, new air is continuously introduced and used air removed.

Preferably, after the evaporation process, the further, forced drying of the lacquer coating by means of a nozzle drier takes place. As a large portion of the volatile constituents below the surface of the lacquer coating has already escaped as a result of the evaporation according to the invention, there is also no danger that bubbles or cracks will form during the subsequent rapid and intensive drying by the nozzle drier.

Vis-á-vis conventional methods, the evaporation method according to the invention therefore makes possible, in combination with the subsequent forced drying, shorter drying times with qualitatively better coating results with many fewer coating defects caused by drying.

It is advantageous if at least one infrared radiator is used to generate the electromagnetic radiation. An infrared radiator with an emission spectrum adapted in targeted manner to the absorption curve of the volatile lacquer constituents is particularly preferably used (in the area of emissivity >0.8 through resonance of the radiation frequencies and the natural vibration frequencies of the molecules of the volatile lacquer constituents). This permits an efficient and low-loss energy transmission into the lacquer coating, because, as a result of the adaptation, a large proportion of the emitted radiation is also absorbed as desired by the solvent in the lacquer.

However, when energy efficiency is poorer, conventional IR radiators without adapted emission spectrum can also be used.

Furthermore, to generate the electromagnetic radiation, at least one microwave generator, in particular a magnetron, can also be used. If is also conceivable to use the microwave generator together with an infrared radiator. However, a microwave generator can also be used instead of an infrared radiator. A microwave generator is advantageous in particular if the lacquer to be evaporated is a lacquer with water as solvent. In fact, water molecules in the liquid aggregate state can be efficaciously excited to oscillate by microwave radiation due to their electric dipolar property, heat energy being released. This allows a particularly efficient energy transmission into the water-containing lacquer coating. The frequency of the microwave generator is preferably the range, approved in Europe, around 2.45 GHz.

However, it is also conceivable to use another approved, higher frequency.

The frequency of the microwave generator lies particularly preferably in the range between 2.45 GHz and 4.9 GHz.

Finally, to achieve the above-named object, the present invention also proposes a device for carrying out one or more of the methods just described.

### BRIEF DESCRIPTION OF THE FIGURES

The single FIGURE is a schematic representation of a device with which a method according to the invention can be carried out.

### DESCRIPTION OF PREFERRED VERSIONS

The FIGURE shows a device 1 with two boundaries 2a and 2b which together enclose an evaporation zone 3. Several electromagnetic radiation sources 4 which can emit an electromagnetic radiation 5 are arranged inside the evaporation zone 3. The arrangement and number of radiation sources 4 can vary as required. Two workpieces 6a and 6b are shown between the radiation sources 4. The workpiece 6a is covered on all sides with a solvent-containing liquid lacquer coating 7a. On the other hand, the workpiece 6b is only partially coated with a corresponding lacquer coating 7b.

The device 1 also has an air treatment unit with feed air 8a and discharge air 8b. This can be a fresh-air unit. Alternatively, a circulation system can also be provided, as indicated by the dashed arrow 9.

The operation of the device 1 is explained below.

Firstly, the starting point is that the workpiece 6a is coated on all sides. This workpiece 6a has been provided on all sides with a lacquer coating in a coating process I not shown in more detail. The workpiece 6a is then, as indicated by the arrow A, introduced into the device 1. The evaporation II of the applied lacquer coating takes place in the device 1. For this, the workpiece 6a is passed through the evaporation zone 3.

A moist and cool atmosphere prevails in the evaporation zone 3 as a result of the air conditioned according to the feed 8a and the discharge 8b. The movement of the-conditioned air in the evaporation zone 3 takes place against the direction of movement of the workpiece 6a through the evaporation zone 3. This is achieved in that the feed air 8a is blown in at the rear end of the device 1 in the direction of the workpiece 6a and the spent air is sucked out of the workpiece 6a in the form of discharge air 8b at the front end.

At the same time, an irradiation of the lacquer coating 7a with electromagnetic radiation 5 takes place by means of the radiation sources 4, infrared and/or microwave radiation also being able to be used. Thanks to the moist and cool atmosphere, the surface of the lacquer coating 7a is prevented from drying out during its evaporation. The surface of the lacquer coating 7a remains permeable. Therefore the deeper volatile constituents of the lacquer coating can emerge unimpeded from the lacquer when they are excited by the radiation 5.

Once the lacquer coating 7a has been well evaporated through the interaction of the moist and cool air and the irradiation, the workpiece leaves the evaporation zone 3 at the rear end of the device 1. The workpiece, as indicated by the arrow B, is then conveyed to the actual drying process III.

The evaporation of the only partially coated workpiece 6b takes place in a similar manner to the just-described evaporation of the workpiece 6a. However, the workpiece 6b is not irradiated at the sites at which there is no lacquer. To achieve this, specific radiation sources 4 can simply remain switched off during the evaporation phase II. Alternatively, the device 1 can be designed specifically for the evaporation of the workpiece 6b, with the result that the arrangement of the radiation sources 4 is such that an irradiation of uncoated workpiece parts is avoided.

With the method according to the invention and the device according to the invention, a much better and more thorough evaporation of solvent-containing lacquers is achieved. Thus in the subsequent drying process with increased energy action, the formation of coating defects can be effectively avoided.

### LIST OF REFERENCE NUMBERS

1 evaporator
2a upper boundary
2b lower boundary
3 evaporation zone
4 radiation source
5 radiation
6a workpiece coated on all sides
6b partially coated workpiece
7a, 7b lacquer coating
8a feed air
8b discharge air
9 circulating air
I coating
II evaporation
III drying

1. A method for the drying of a solvent-containing lacquer coating (7) applied to a workpiece (6), characterized by the step of feeding moisture- and chill-conditioned air onto the workpiece (6) with simultaneous energy input into the lacquer coating (7) by exposure to electromagnetic radiation (5).

2. The method according to claim 1, characterized in that the conditioned air is conditioned to a temperature in the range from +1° C. to +18° C. and/or an air humidity in the range from 50% to 90% relative humidity.

3. The method according to claim 1, characterized in that the energy is also input into the workpiece (6).

4. The method according to claim 1, characterized in that the conditioned air is supplied in the form of fresh air or circulating air (9).

5. The method according to claim 1 further comprising the step of drying (III) of the lacquer coating (7) by means of a nozzle drier.

6. The method according to claim 1, characterized in that at least one infrared radiator is used to generate the electromagnetic radiation (5).

7. The method according to claim 6, characterized in that an infrared radiator with an emission spectrum adapted in particular to the absorption curve of the volatile lacquer constituents is used.

8. The method according to claim 1, characterized in that at least one microwave generator, in particular a magnetron, is used to generate the electromagnetic radiation.

9. The method according to claim 8, characterized in that the frequency range of the microwave generator lies at 2.45 GHz or higher.

10. A device for carrying out a method according to claim 1.
